(19) United States
(12) Patent Application Publication
(10) Pub. No.: US 2025/0067508 A1
(43) Pub. Date: Feb. 27, 2025

(54) DRYING APPARATUS

(71) Applicant: KYOCERA Document Solutions Inc., Osaka (JP)

(72) Inventors: Mitsuhiro GODA, Osaka-shi (JP); Masaki MURASHIMA, Osaka-shi (JP); Hiroyuki UEDA, Osaka-shi (JP); Minoru TOKONAMI, Osaka-shi (JP)

(73) Assignee: KYOCERA Document Solutions Inc., Osaka (JP)

(21) Appl. No.: 18/806,651

(22) Filed: Aug. 15, 2024

(30) Foreign Application Priority Data
Aug. 22, 2023 (JP) 2023-134657

(51) Int. Cl. F26B 3/30; F26B 25/08

(52) U.S. Cl. CPC F26B 3/30; F26B 25/08

(57) ABSTRACT

A drying device dries a recording medium on which an image is formed, while conveying the recording medium. The drying apparatus includes a conveying member and a heating device. The conveying member supports and conveys the recording medium in a predetermined conveyance direction. The heating device heats the recording medium conveyed by the conveying member under a high temperature environment. The heating device includes a heater, a reflector and a lifting mechanism. The heater emits infrared ray. The reflector reflects the infrared ray emitted from the heater toward the recording medium. The lifting mechanism lifts and lowers the reflector relative to the heater to change a number of reflections of the infrared ray.

### INCORPORATION BY REFERENCE

This application is based on and claims the benefit of priority from Japanese patent application No. 2023-134657 filed on Aug. 22, 2023, which is incorporated by reference in its entirety.

### BACKGROUND

The present disclosure relates to a drying apparatus which dries a recording medium on which an image is formed by an inkjet recording method, while conveying the recording medium.

An image forming system including an inkjet type image forming apparatus is provided with a drying apparatus which dries an image formed on a recording medium by ink. The drying apparatus may be provided with a fan which takes in outside air and blows it onto the recording medium, a plurality of heaters which emit infrared ray, and a plurality of reflector plates each of which is provided for each heater and reflects infrared ray emitted from the heater toward the recording medium.

In the above-described drying apparatus, an optimum degree of drying of the recording medium (the ink) differs depending on a type of the ink, an ejection amount of the ink, a type of the recording medium, and the others. However, since the heater can generally only be switched between an ON state and an OFF state, intensity of the infrared ray emitted to the recording medium is always constant. In other words, it is difficult to change the intensity of infrared ray emitted from the heater to the recording medium so as to obtain an optimum condition corresponding to ae state of the recording medium (the ink). Therefore, when a type of the ink or the recording medium is changed, the heater itself may need to be replaced.

### SUMMARY

A drying device according to the present disclosure dries a recording medium on which an image is formed, while conveying the recording medium. The drying apparatus includes a conveying member and a heating device. The conveying member supports and conveys the recording medium in a predetermined conveyance direction. The heating device heats the recording medium conveyed by the conveying member under a high temperature environment. The heating device includes a heater, a reflector and a lifting mechanism. The heater emits infrared ray. The reflector reflects the infrared ray emitted from the heater toward the recording medium. The lifting mechanism lifts and lowers the reflector relative to the heater to change a number of reflections of the infrared ray.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view showing an inside of a drying apparatus according to one embodiment of the present disclosure.

FIG. 2 is a view showing a lifting mechanism for a reflecting plate, in the drying apparatus according to the embodiment of the present disclosure.

FIG. 3A is a front view schematically showing infrared ray reflected by the reflection plate (when it is lowered), in the drying apparatus according to the embodiment of the present disclosure.

FIG. 3B is a front view schematically showing infrared ray reflected by the reflection plate (when it is lifted), in the drying apparatus according to the embodiment of the present disclosure.

### DETAILED DESCRIPTION

Hereinafter, with reference to the drawings, a drying apparatus according to one embodiment of the present disclosure will be described.

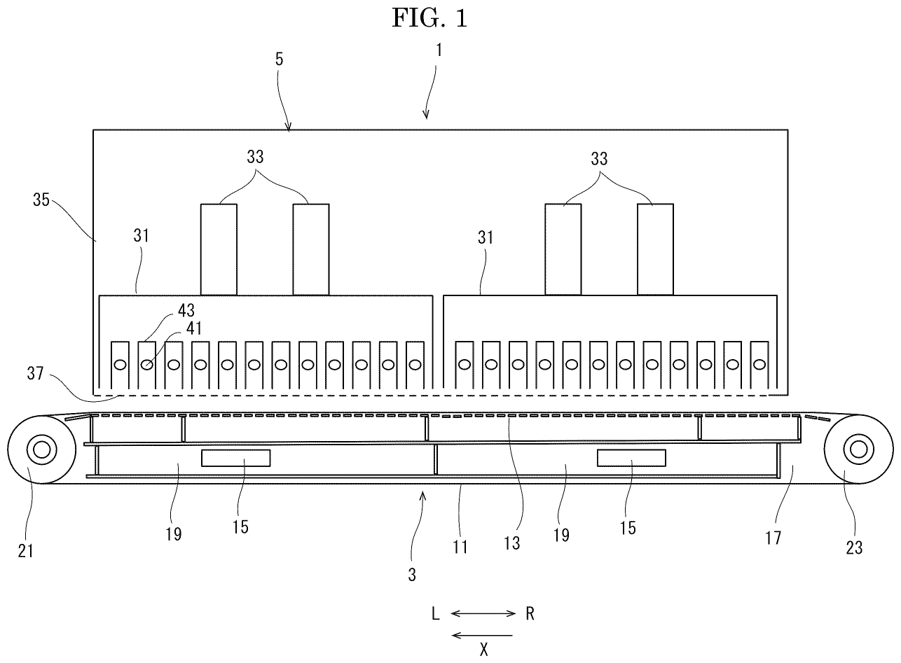

First, the entire structure of the drying apparatus 1 will be described with reference to FIG. 1. FIG. 1 is a front view showing the inside of the drying apparatus 1. In each figure, Fr, Rr, L, and R indicate the front side, rear side, left side, and right side of the drying apparatus 1, respectively.

The drying apparatus 1 includes a conveying device 3 which conveys a recording medium on which an image is formed by an inkjet method, and a heating device 5 which dries the ink of the recording medium conveyed by the conveying device 3 under a high-temperature environment.

First, the conveying device 3 will be described. The conveying device 3 includes a conveying belt 11 on which the recording medium is conveyed along a conveyance direction X from the right to the left in FIG. 1, a conveying plate 13 which supports the conveying belt 11, a suction device 15 which attracts the recording medium to the conveying belt 11, and front and rear side plates 17 which support them.

First, the front and rear side plates 17 will be described. The front and rear side plates 17 are plate-like members elongated in a width direction (a direction intersecting the conveyance direction X, the left-and-right direction), and are arranged at an interval in the front-and-rear direction. Two rooms 19 arranged in the conveyance direction X are formed in the lower portion of the space between the front and rear side plates 17.

A driving roller 21 and a driven roller 23 are supported between the front and rear side plates 17. The driving roller 21 is rotatably supported at the downstream side end portions (the left end portions) of the front and rear side plates 17 in the conveyance direction X. The driven roller 23 is rotatably supported at the upstream side end portions (the right end portions) of the front and rear side plates 17 in the conveyance direction X. The drive shaft of the driving roller 21 is connected to a motor (not shown).

Next, the conveying belt 11 will be described. The conveying belt 11 is an endless belt, and a number of through-holes penetrating in the thickness direction are formed on the entire surface. The conveying belt 11 is wound around the driving roller 21 and the driven roller 23. When the driving roller 21 is driven by the motor to be rotated, the conveying belt 11 circulates and travels in the counterclockwise direction of FIG. 1. The outer surface of the conveying belt 11 along the upper track is a conveying surface on which the recording medium is conveyed. As described above, the conveying belt 11 is an example of the conveying member conveying the recording medium in the present disclosure.

Next, the conveying plate 13 will be described. The conveying plate 13 is supported by the front and rear side plates 17 so as to be in contact with the inner circumferential surface (the surface opposite to the conveying surface) of the conveying belt 11 traveling on the upper track. When the conveying belt 11 travels, the inner circumferential surface of the conveying belt 11 slides along the upper surface of the conveying plate 13. A number of through-holes penetrating in the thickness direction are formed on the entire surface of the conveying plate 13.

Next, the suction device 15 will be described. The suction device 15 is disposed in each of two rooms 19 formed between the front and rear side plates 17. When the suction device 15 is driven, air in the through-holes of the conveying belt 11 and the through-holes of the conveying plate 13 is evacuated. Thus, the recording medium on the conveying surface of the conveying belt 11 is attracted to the conveying belt 11.

Next, the heating device 5 will be described. The heating device 5 includes two heater units 31, two fans 33 provided in the heater units 31, and a housing 35 in which they are housed.

The housing 35 is formed in a box shape with an open lower surface. The opening of the lower surface is covered with a protective net 37.

The two heater units 31 are arranged side by side in the conveyance direction X in the hollow space of the housing 35. Each heater unit 31 has a plurality of infrared heaters 41 arranged side by side in the conveyance direction X, and a reflector 43 for reflecting infrared ray emitted from each infrared heater 41. The infrared heater 41 emits infrared ray mainly from the lower half. The reflector 43 has a box shape with an open lower surface, and has a top plate, right and left side plates, and front and rear side plates. The inner surface of each plate is mirror machined. The reflector 43 is arranged to surround the heater 41. Infrared ray emitted from the heater 41 is reflected mainly on the inner surfaces of the left and right side plates and the front and rear side plates of the reflector 43 several times, and is irradiated downward.

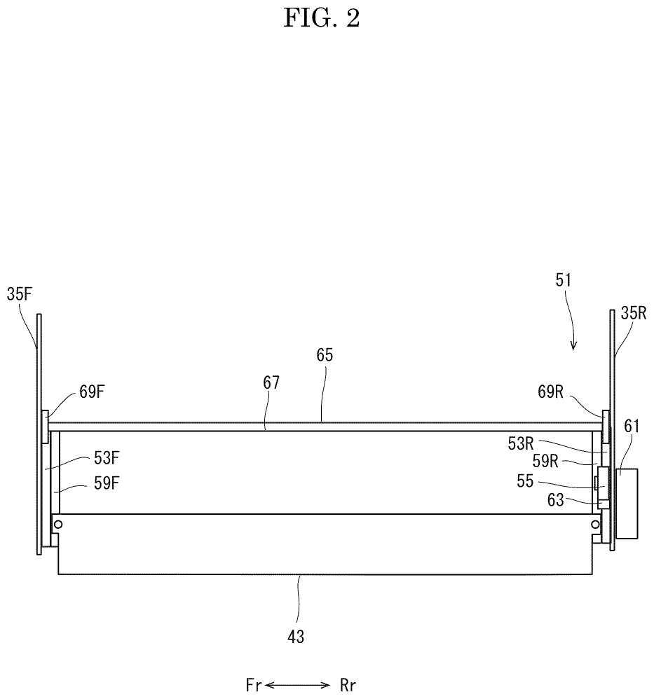

The reflectors 43 are supported by a lifting mechanism 51 including a rack and pinion mechanism so as to be lifted and lowered. The lifting mechanism 51 will be described with reference to FIG. 2. FIG. 2 shows the lifting mechanism 51.

The lifting mechanism 51 includes rack gears 53 (53F, 53R) fixed to the reflector 43 and a pinion gear 55 rotatably supported by the rear side plate 35R of the housing 35. The front and rear end portions of the reflector 43 are suspended and supported by front and rear support plates 59F and 59R. The front and rear support plates 59F and 59R are fixed to the front and rear rack gears 53F and 53R. The front and rear rack gears 53F and 53R are supported on the inner surfaces of the front and rear side plates 35F and 35R of the housing 35 in a movable manner along the upper-and-lower direction.

The pinion gear 55 is rotatably supported on the inner surface of the rear side plate 35R, and engaged with the rear rack gear 53R. A drive motor 61 is supported on the rear surface of the rear side plate 35R. The drive shaft of the drive motor 61 passes through the rear side plate 35R. A drive gear 63 is fixed to the distal end of the drive shaft protruding from the rear side plate 35R. The drive gear 63 is engaged with the pinion gear 55.

A connection member 65 for moving the front and rear rack gears 53F and 53R synchronously is arranged between the front and rear side plates 35F and 35R. The connection member 65 has a rotary shaft 67, and front and rear gears 69F and 69R fixed to both ends of the rotary shaft 67. Both the end portions of the rotary shaft 67 are rotatably supported by the front and rear side plates 35F and 35R. The front and rear gears 69F and 69R are engaged with the front and rear rack gears 53F and 53R, respectively.

When the drive motor 61 is driven, the pinion gear 55 is rotated with the rotation of the drive gear 63. Thus, the rear rack gear 53R engaged with the pinion gear 55 is lifted and lowered. As the rear rack gear 53R is lifted and lowered, the rear gear 69R of the connection member 65 is rotated. Then, the front gear 69F is rotated together with the rear gear 69R, and the front rack gear 53F engaged with the front gear 69F is lifted and lowered in synchronization with the rear rack gear 53R. Thus, the reflectors 43 supported by the support plates 59F and 59R are lifted and lowered integrally.

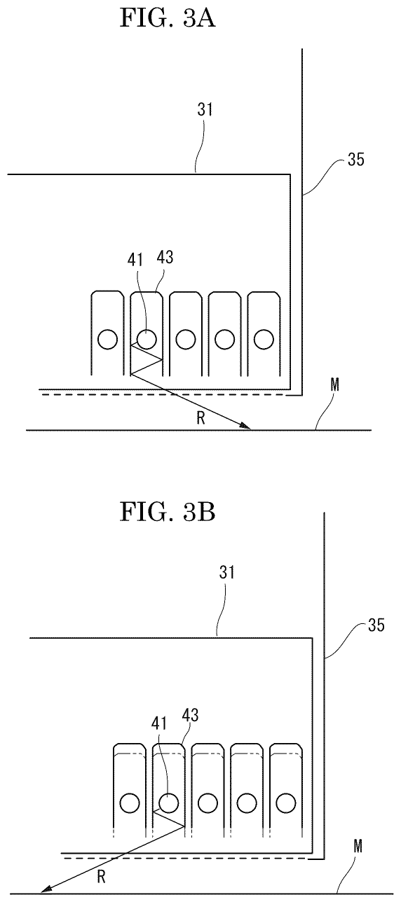

The reflectors 43 are lifted and lowered between a lower position and an upper position by the lifting mechanism 51. In the lower position, the heater 41 is positioned approximately in the center of the reflector 43 in the height direction, and the length of the reflector 43 (the front and rear side plates, and the left and right side plates) below the heater 41 is increased (described later with reference to FIG. 3A). In the upper position, the heater 41 is positioned slightly below the center of the reflector 43 in the height direction, and the length of the reflector 43 (the front and rear side plates, the left and right side plates) below the heater 41 is shortened (described later with reference to FIG. 3B). That is, as the reflector 43 is lifted and lowered, a number of times where infrared ray is reflected on the side plates of the reflector 43 is changed (described later in detail).

With reference to FIG. 1 again, the two fans 33 are provided on the upper surface of each heater unit 31. The fan 33 takes in air in the housing 35, and blows it downward. The downward blown air is heated by passing through the heater unit 31 to generate downward hot air.

The heating device 5 is disposed above the conveying surface of the conveying belt 11 of the conveying device 3 at a predetermined interval from the conveying surface.

The drying operation of the drying apparatus 1 having the above configuration will be described with reference to FIG. 3A and FIG. 3B. FIG. 3A and FIG. 3B are views schematically showing the reflection of infrared ray on the reflector 43.

In the conveying device 3, the driving roller 21 is driven to be rotated, and the conveying belt 11 travels. Thereafter, the recording medium on which the image is formed by the inkjet method is conveyed to the conveying surface of the conveying belt 11. The suction device 15 is driven. Thereby, as described above, air in the through-holes of the conveying belt 11 and the through-holes of the conveying plate 13 is evacuated, and the space above the conveying surface of the conveying belt 11 becomes negative pressure. Then, the recording medium is attracted to the conveying surface. Thus, the recording medium is conveyed along the conveyance direction X while being attracted to the conveying surface.

Further, the heater units 31 and the fans 33 of the heating device 5 are driven. The reflector 43 of the heater unit 31 is lowered to the lower position by the lifting mechanism 51. As described above, infrared ray emitted from the infrared heater 41 is reflected by the reflector 43, and irradiated downward. Specifically, as shown in FIG. 3A, the infrared ray R emitted from a predetermined position of the infrared heater 41 is reflected by the left side plate, reflected by the right side plate, and then reflected by the left side plate, and irradiated toward the recording medium. Thus, in this example, a number of the reflections is three.

The air blown downward by the fan 33 is heated by passing through the heater units 31 to generate downward hot air. Thus, the heating device 5 blows the heated air (the hot air) downward. The recording medium (the ink) conveyed on the conveying surface of the conveying belt 11 is dried by such infrared ray and hot air.

In the case where an amount of the ink ejected onto the recording medium is larger than the standard amount, or in the case where the recording medium has a characteristic in which the ink hardly adheres, it is necessary to increase strength (drying strength) of drying the ink more than the standard condition by increasing an irradiance of infrared ray irradiated onto the recording medium.

In this case, as described above, the pinion gear 55 of the lifting mechanism 51 is rotated to lift the rack gears 53F and 53R, and the reflector 43 is lifted to the upper position together with the support plates 59F and 59R. Then, as shown in FIG. 3B, infrared ray R emitted from a predetermined position of the infrared heater 41 is reflected by the left side plate, reflected by the right side plate, and then irradiated toward the recording medium. In this example, a number of the reflections is two. A number of the reflections of infrared ray is smaller than in the case shown in FIG. 3A (the case where the reflector 43 is lowered to the lower position, a number of the reflections is three).

Each time infrared ray is reflected by the reflector 43, the intensity of infrared ray is weakened by diffusion or absorption by the reflector 43. In other words, the more the number of reflections, the weaker the intensity. Therefore, an amount of infrared ray diffused or absorbed by the reflector becomes smaller than in the case shown in FIG. 3A, so that the illuminance of infrared ray irradiated on the recording medium is increased. Therefore, the recording medium can be dried at the higher drying strength than the standard condition.

As is clear from the above description, according to the drying apparatus 1 of the present disclosure, the strength of drying the recording medium (the ink) can be changed by lifting and lowering the reflector 43. More specifically, when it is desired to increase the illuminance of infrared ray irradiated on the recording medium, a number of the reflection of infrared ray is decreased by lifting the reflector 43. Therefore, the recording medium can be dried at a strength suitable for the recording medium without replacing the heater 41.

Since the lifting mechanism 51 for lifting and lowering the reflector 43 includes a rack and pinion mechanism, the reflector 43 can be accurately lifted and lowered to the upper position and the lower position with a simple constitution. The position of the reflector 43 is not limited to the upper position and the lower position, and may be lifted or lowered to a height other than these positions (height). The lifting mechanism 51 is not limited to a rack and pinion mechanism. For example, a solenoid may be used to lift and lower the reflector 43 through the support plates 59F and 59R. Alternatively, the support plates 59F and 59R may be suspended by a wire, and the wire may be wound or rewound by a winding roller to lift or lower the reflector 43.

It should be noted that the user or the service person determines whether it is necessary to increase the drying strength of the recording medium. In this case, for example, a selection button is provided on an operation panel of the drying apparatus 1. When it is necessary to increase the drying strength, he pushes the selection button. Then, the motor 61 is driven, and the reflector 43 is lifted to the upper position.

Further, in the above embodiment, a configuration for simultaneously lifting and lowering the reflectors 43 has been described, but the reflectors 43 may be individually lifted and lowered. For example, on the upstream side in the conveyance direction X, the reflectors 43 are lowered to the lower position to decrease the illuminance of infrared ray irradiated on the recording medium. On the other hand, on the downstream side in the conveyance direction X, the reflectors 43 are lifted to the upper position to increase the illuminance of infrared ray irradiated on the recording medium. Alternatively, the height of the reflectors 43 is gradually increased from the upstream side to the downstream side of the conveyance direction X. Thus, for example, when the ink that is easy to dry is used, the illuminance of infrared ray irradiated on the recording medium is decreased on the upstream side of the conveyance direction X, so that the sudden drying of the ink can be prevented and the ink can be gradually dried.

Although the present disclosure has been described in particular embodiments, the present disclosure is not limited to the foregoing embodiments. To the extent that it does not deviate from the scope and object of the present disclosure, the foregoing embodiments may be variously modified, substituted, or modified, and the claims include all embodiments that may fall within the scope of technical thought.

1. A drying device which dries a recording medium on which an image is formed, while conveying the recording medium, the drying apparatus comprising:
a conveying member which supports and conveys the recording medium in a predetermined conveyance direction; and
a heating device which heats the recording medium conveyed by the conveying member under a high temperature environment, wherein,
the heating device includes:
a heater which emits infrared ray;
a reflector which reflects the infrared ray emitted from the heater toward the recording medium; and
a lifting mechanism which lifts and lowers the reflector relative to the heater to change a number of reflections of the infrared ray.

2. The drying apparatus according to claim 1, wherein,
the lifting mechanism lifts the reflector to decrease the number of reflections when intensity of the infrared ray irradiated on the recording medium is desired to be increased.

3. The drying apparatus according to claim 1, wherein,
the reflector includes a plurality of the reflectors, and
the lifting mechanism lifts and lowers the reflectors at the same time.

4. The drying apparatus according to claim 1, wherein,
the reflector includes a plurality of the reflectors, and
the lifting mechanism lifts and lowers the reflectors individually.

5. The drying apparatus according to claim 1, wherein,
the lifting mechanism is a rack and pinion mechanism.
